(19) United States
(12) Patent Application Publication
(10) Pub. No.: US 2011/0248969 A1
(43) Pub. Date: Oct. 13, 2011

(54) LCD DISPLAY APPARATUS AND LCD DRIVING METHOD

(75) Inventors: Hoon CHOI, Hwaseong-si (KR); Kwang-youn KIM, Suwon-si (KR)

(73) Assignee: SAMSUNG ELECTRONICS CO., LTD., Suwon-si (KR)

(21) Appl. No.: 13/071,024

(22) Filed: Mar. 24, 2011

Related U.S. Application Data
(60) Provisional application No. 61/322,055, filed on Apr. 8, 2010.

(30) Foreign Application Priority Data
May 28, 2010 (KR) 10-2010-0049943

(51) Int. Cl. G09G 5/00

(52) U.S. Cl. 345/204

(57) ABSTRACT

A liquid crystal display (LCD) apparatus and an LCD driving method are provided. The LCD apparatus drives an LCD module by applying temperature compensation to change driving timing according to temperature of the LCD module. Accordingly, the LCD apparatus may reduce a cross-talk occurrence rate in low temperature.

### CROSS-REFERENCE TO RELATED APPLICATIONS

This application claims priority from Korean Patent Application No. 10-2010-0049943, filed on May 28, 2010, and U.S. Provisional Application Ser. No. 61/322,055 filed on Apr. 8, 2010, the disclosures of which are incorporated herein in their entirety by reference.

### BACKGROUND

1. Field of the Invention

Apparatuses and methods consistent with exemplary embodiments relate to a liquid crystal display (LCD), and more particularly to an LCD apparatus to play a three-dimensional (3D) image and an LCD driving method thereof.

2. Description of the Prior Art

Recently, a display apparatus is getting thinner, and a light emitting diode (LED) is applied more widely with the development of LED technology. Particularly, as an LED is used as a backlight of a display apparatus, it becomes possible to make the display apparatus extremely thin.

In order to make a thin display apparatus using an LED, an edge-type backlight in which an LED backlight is disposed on the edge of the display apparatus is often used.

However, such an edge-type backlight has disadvantages in that temperature on the edge of the LCD may increase while temperature at the center of the screen may drop. If the temperature of an LCD goes down, response speed of the LCD also slows down, making it difficult to provide a high quality image. In particular, since a 3D image increases the frequency to output a screen, it requires faster response time.

A 3D image displays a left eye image and a right eye image alternately. Therefore, if response time of an LCD slows down in a 3D image, cross-talk effect where a left eye image and a right eye image appear to be overlapped with each other may occur. In order to display a 3D image appropriately, fast response time is required.

A user desires to view a 3D image with less cross-talk effect. Accordingly, a method for providing a display apparatus to reduce cross-talk effect is required.

### SUMMARY

One or more exemplary embodiments relate to an LCD apparatus which drives an LCD module by applying temperature compensation to compensate driving timing according to temperature of the LCD module and an LCD driving method thereof.

According to an aspect of an exemplary embodiment, there is provided an LCD apparatus which may include an LCD module which displays an input image, and a controller which drives the LCD module by applying temperature compensation to change driving timing of the LCD module according to temperature of the LCD module.

The controller may include a timing controller which controls the driving timing of the LCD module based on the input image and a main controller which controls the timing controller to control the driving timing based on the input image, and the main controller may control the timing controller to drive the LCD module by applying the temperature compensation to change the driving timing controlled based on the input image according to the temperature of the LCD module.

The LCD apparatus may further include a temperature sensor which senses the temperature of the LCD module, and the main controller may apply the temperature compensation according to the temperature of the LCD module sensed by the temperature sensor.

The LCD apparatus may further include a storage unit which stores temperature compensation data including a plurality of temperature compensation values corresponding to a plurality of temperatures, respectively, and the main controller may extract from the storage unit a temperature compensation value corresponding to the temperature, and apply the temperature compensation using the extracted temperature compensation value.

The main controller may control the timing controller to correct a driving signal to drive the LCD module according to the extracted temperature compensation value.

The main controller may apply the temperature compensation according to a setting value set by a user's manipulation.

According to an aspect of another exemplary embodiment, the main controller may include a timing controller which controls driving timing of the LCD module according to the input image and a main controller which controls the timing controller to control the driving timing according to an input image, and the timing controller may drive the LCD module by applying the temperature compensation to change the driving timing according to the temperature of the LCD module.

The LCD apparatus may further include a temperature sensor which senses the temperature of the LCD module, and the timing controller may apply the temperature compensation according to the temperature of the LCD module sensed by the temperature sensor.

The LCD apparatus may further include a storage unit which stores temperature compensation data including a plurality of temperature compensation values corresponding to a plurality of temperatures, respectively, and the timing controller may extract from the storage unit a temperature compensation value corresponding to the temperature, and apply the temperature compensation using the extracted temperature compensation value.

The timing controller may correct a driving signal to drive the LCD module according to the extracted temperature compensation value.

The timing controller may apply the temperature compensation according to a setting value set by a user's manipulation.

According to an aspect of another exemplary embodiment, there is provided an LCD driving method which may include generating a driving signal to drive an LCD module, applying temperature compensation to the driving signal according to temperature of the LCD module and changing driving timing of the LCD module according to the driving signal to which the temperature compensation is applied.

The LCD driving method may further include sensing the temperature of the LCD module by a temperature sensor.

The LCD driving method may further include storing temperature compensation data including a plurality of temperature compensation values corresponding to a plurality of temperatures, respectively and extracting a temperature compensation value corresponding to the temperature from the stored temperature compensation data, and the applying the temperature compensation may be performed using the extracted temperature compensation value.

The applying the temperature compensation may include applying the temperature compensation to correct the generated driving signal according to the extracted temperature compensation value.

The LCD driving method may further include receiving an input of a setting value regarding the temperature compensation by a user's manipulation, and the applying may include applying the temperature compensation according to a setting value set by a user's manipulation.

As described above, according to various exemplary embodiments, an LCD apparatus which drives an LCD module by applying temperature compensation to change driving timing according to temperature of the LCD module and an LCD driving method thereof are provided. Accordingly, a cross-talk occurrence rate is reduced and a user may view a 3D image in various environments without cross-talk effect.

### BRIEF DESCRIPTION OF THE DRAWINGS

The above and/or other aspects will be more apparent with reference to the accompanying drawings, in which:

FIG. 1A is a block diagram illustrating a structure of a TV in which temperature compensation is performed by a main controller according to an exemplary embodiment;

FIG. 1B is a block diagram illustrating a structure of a TV in which temperature compensation is performed by a timing controller according to an exemplary embodiment;

FIG. 2 is a flowchart to explain an LCD driving method according to an exemplary embodiment;

FIG. 3A is a view illustrating a screen to set a temperature compensation mode according to an exemplary embodiment;

FIG. 3B is a view illustrating a screen when a temperature compensation mode is set to an automatic mode according to an exemplary embodiment;

FIG. 3C is a view illustrating a screen when a temperature compensation mode is set to a manual mode according to an exemplary embodiment; and

FIGS. 4A and 4B are views illustrating graphs showing a cross-talk occurrence rate before and after applying temperature compensation according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

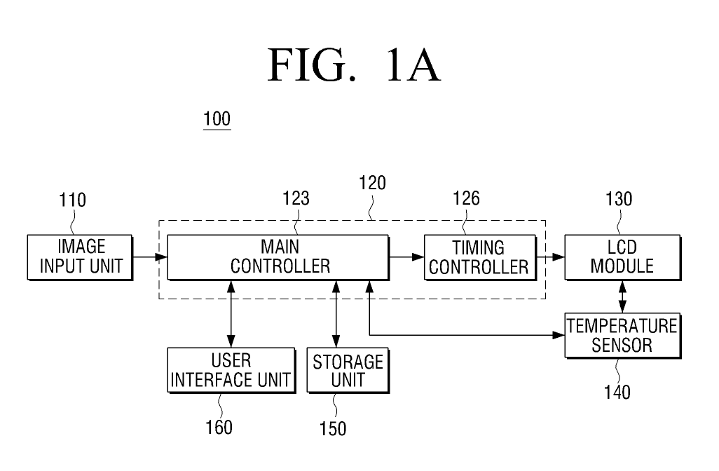

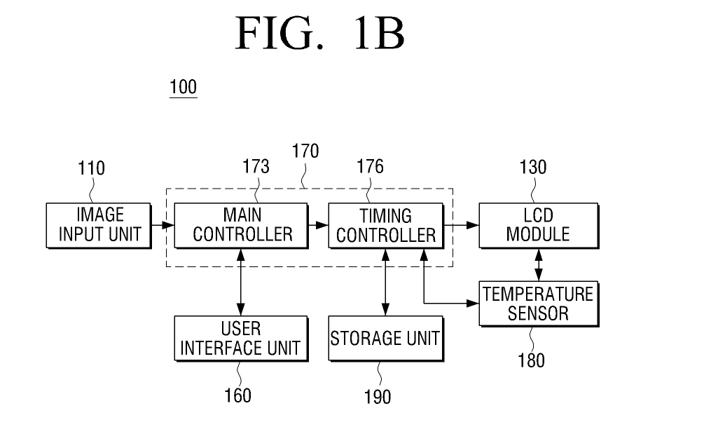

FIG. 1A is a block diagram illustrating a structure of an LCD TV 100 in which temperature compensation is performed by a main controller according to an exemplary embodiment. As illustrated in FIG. 1A, the LCD TV 100 comprises an image input unit 110, a controller 120, an LCD module 130, a temperature sensor 140, a storage unit 150, and a user interface 160.

The image input unit 110 receives an input image signal from the outside. Specifically, the image input unit 110 may be a tuner to receive a broadcasting signal or an audio/video (A/V) interface to receive a wired broadcast, an analog image signal, or a digital image signal.

The controller 120 generates a driving signal to drive the LCD module 130 according to the input image signal, and applies the generated driving signal to the LCD module 130. Here, the controller 120 controls to correct the driving signal by applying temperature compensation to change driving timing according to the temperature of the LCD module 130, and to drive the LDC module 130 according to the corrected driving signal.

In this case, the temperature compensation means applying correction to the driving signal according to the temperature of the LCD module 130. The lower the temperature of the LCD is, the slower the response time of the LCD becomes. Accordingly, the controller 120 generates a driving signal by applying correction to increase the response time as the temperature of the LCD module 130 slows down. Here, correction to the driving signal may be performed by adjusting a driving current or a driving voltage. In other words, the controller 120 may apply correction to the driving signal by adjusting a driving current, a driving voltage or a duty ratio. In this case, a temperature compensation value, that is, a correction value, is used for temperature compensation. Therefore, a temperature compensation value refers to a value to change the intensity of a duty ratio of a driving signal according to temperature of the LCD module 130.

As such, the controller 120 applies temperature compensation when a driving signal is generated, and thus, the LCD module 130 may maintain its high response speed even if the temperature is low.

As illustrated in FIG. 1A, the controller 120 comprises a main controller 123 and a timing controller 126. The main controller 120 controls overall operation of the LCD TV 100. Specifically, the main controller 123 performs signal-processing on an image signal input through the image input unit 110, and outputs the processed image signal to the timing controller 126. In addition, the main controller 123 controls various operations of the LCD TV 100.

The main controller 123 controls the timing controller 126 to drive the LCD module by applying temperature compensation to change driving timing according to the temperature of the LCD module 130. That is, the main controller 123 applies temperature compensation to an input image signal, and outputs the image signal to which temperature compensation is applied to the timing controller 126.

Specifically, the main controller 123 may apply temperature compensation according to temperature sensed by the temperature sensor 140. For example, if an automatic mode is set for temperature compensation, the main controller 123 receives information regarding temperature of the current LCD module 130 from the temperature sensor 140. The main controller 123 extracts a temperature compensation value corresponding to the temperature information using temperature compensation data stored in the storage unit 150. Subsequently, the main controller 123 controls the timing controller 126 to correct a driving signal applied to the LCD module 130 according to the extracted temperature compensation value. By doing so, the main controller 123 may automatically apply temperature compensation to the input image signal according to the temperature of the LCD module 130.

In addition, the main controller 123 may apply temperature compensation according to a setting value set by a user's manipulation. For example, if a manual mode is set for temperature compensation, the main controller 123 selects a setting value for temperature compensation according to a user's command input through the user interface unit 160. The setting value for temperature compensation refers to a value for temperature compensation selected by a user. For example, temperature compensation setting value may be ‘−1’ for 15 degrees, ‘0’ for 20 degrees’, and ‘+1’ for 25 degrees.

Furthermore, the main controller 123 extracts a temperature compensation value corresponding to the temperature information using temperature compensation data stored in the storage unit 150. Subsequently, the main controller 123 controls the timing controller 126 to correct a driving signal applied to the LCD module 130 according to the extracted temperature compensation value. The temperature compensation value is a value to correct a driving signal according to temperature and can be obtained using temperature compensation data which is preset through an experiment.

By doing so, the main controller 123 may manually apply temperature compensation to the input image signal according to the temperature of the LCD module 130 by a user's manipulation.

The timing controller 126 controls the driving timing of the LCD module according to the image signal input from the main controller 123. That is, the timing controller 126 generates a driving signal based on the input image signal, and applies the generated driving signal to the LCD module 130. Therefore, the timing controller 126 is able to drive the LCD module 130, and controls the driving timing at the same time. In particular, since the main controller 123 applies temperature compensation to an input image signal and output it, the timing controller may generate a driving signal to which temperature compensation is applied. Therefore, the timing controller 126 generates the driving signal of the LCD module 130 based on the image signal to which temperature compensation is applied, and provides the driving signal to the LCD module 130 in time.

The timing controller 126 may be a timing control board or a timing control (TCON) board, according to an exemplary embodiment.

The LCD module 130 displays an input image signal according to driving control by the timing controller 126. The LCD module 130 includes a liquid panel and various optical sheets. In addition, the LCD module 140 includes backlight. Herein, the backlight may be implemented in an edge-type. The edge-type backlight means backlight which provides backlight by irradiating light from the side of an LCD. However, other kinds of backlight may also be applied.

The temperature sensor 140 senses the temperature of the LCD module 130. The temperature sensor 140 may be mounted on any part of the LCD module 130. For example, the temperature sensor 140 may be mounted on the center of the back of the LCD module 130. In addition, the temperature sensor 140 transmits temperature information of the sensed LCD module 130 to the main controller 123.

The temperature sensor is divided into a contact-type and a non contact-type. According to the contact-type, temperature is measured through contact with a subject. Examples of the contact-type include a (platinum) resistance temperature sensor, a thermistor, a thermocouple, and a bimetal, and examples of the non contact-type include an infrared thermometer and an optical pyrometer. As such, the temperature sensor 140 may be implemented as various temperature sensors.

The storage unit 150 stores various software necessary to drive the LCD TV 100. In addition, the storage unit 150 stores temperature compensation data corresponding to compensation values of each temperature. The temperature compensation data refers to a table showing compensation values for various temperatures. For example, temperature compensation data may be a DCC table set for each temperature. The storage unit 150 may be various storage media including a non-volatile memory and a hard disk.

The user interface unit 160 receives a command from a user. Specifically, the user interface unit 160 receives a command for a temperature compensation mode and a temperature compensation setting value from a user. The temperature compensation mode means a mode regarding the type of temperature compensation, and includes an automatic mode and a manual mode. If the temperature compensation mode is a manual mode, the user interface unit 160 receives a temperature compensation setting value from a user.

The user interface unit 160 may be a button on the LCD TV 100 or a remote controller.

The LCD TV 100 drives an LCD by applying temperature compensation by the main controller 123, and thus may maintain fast response speed in low temperature. Accordingly, the LCD TV 100 may reduce cross-talk effect while displaying a 3D image.

In the above exemplary embodiment, temperature compensation is applied to the LCD TV 100 by the main controller 123. Specifically, the temperature sensor 140 outputs temperature information to the main controller 123, and temperature compensation data is stored in the storage unit 150 connected to the main controller 123.

However, the LCD TV 100 may be implemented in a way that temperature compensation is applied by the timing controller 126, which will be explained below with reference to FIG. 1B.

FIG. 1B is a block diagram illustrating a structure of the LCD TV 100 in which temperature compensation is performed by a timing controller according to an exemplary embodiment. As illustrated in FIG. 1B, the LCD TV 100 comprises an image input unit 110, a controller 170, an LCD module 130, a temperature sensor 180, a storage unit 190, and a user interface 160.

The structure illustrated in FIG. 1B is similar to the structure illustrated in FIG. 1A. Specifically, the temperature sensor 180 in FIG. 1B is connected to the timing controller 176 and the storage unit 190 is also connected to the timing controller 176. Therefore, only the differences between the structure in FIG. 1B and the structure in FIG. 1A will be explained with reference to FIG. 1B.

The controller 170 generates a driving signal to drive the LCD module 130 according to an input image signal and applies the generated driving signal to the LCD module 130. In this case, the controller 170 controls to correct the driving signal by applying temperature compensation to change driving timing according to the temperature of the LCD module 130, and to drive the LCD module 130 according to the corrected driving signal.

As illustrated in FIG. 1B, the controller 170 comprises a main controller 173 and a timing controller 176. The main controller 173 controls overall operation of the LCD TV 100. Specifically, the main controller 173 performs signal-processing on the image signal input through the image input unit 110, and outputs the processed image signal to the timing controller 176. The main controller 173 also controls other various operations of the LCD TV 100.

In addition, the main controller 173 receives a command to select a temperature compensation mode through the user interface unit 160, and controls the timing controller 176 to perform temperature compensation according to the input mode. For example, if a temperature compensation mode is set to an automatic mode, the main controller 173 controls the timing controller 176 to apply temperature compensation automatically according to the temperature sensed by the temperature sensor 180. On the other hand, if the temperature compensation mode is set to a manual mode, the main controller 173 controls the timing controller 176 to apply temperature compensation according to a setting value input by a user.

The timing controller 176 controls the driving timing of the LCD module according to the image signal input from the main controller 173. That is, the timing controller 176 controls the driving timing and drives the LCD module 130 at the same time by generating a driving signal based on the image signal input from the timing controller 177 and applying the generated driving signal to the LCD module 130. In this case, the timing controller 173 generates a driving signal by applying temperature compensation to the input image signal. Herein, the timing controller 126 may be a timing control board or a TCON board.

The timing controller 176 generates a driving signal by applying temperature compensation to change driving timing according to the temperature of the LCD module 130 and applies the generated driving signal to the LCD module 130.

The timing controller 176 may apply temperature compensation according to temperature information sensed by the temperature sensor 180. For example, if temperature compensation is set to an automatic mode, the timing controller 176 receives temperature information regarding the current LCD module 130 from the temperature sensor 180. Subsequently, the timing controller 176 extracts a temperature compensation value corresponding to the temperature information using temperature compensation data stored in the storage unit 190. The timing controller 176, then, generates a driving signal applied to the LCD module 130 according to the extracted temperature compensation value. By doing so, the controller 176 may automatically apply temperature compensation to the driving signal according to the temperature of the LCD module 130.

In addition, the timing controller 176 may apply temperature compensation according to a setting value set by a user's manipulation. For example, if temperature compensation is set to a manual mode, which means temperature compensation is set by a user, the timing controller 176 receives a temperature compensation setting value corresponding to a user command input through the user interface unit 160 from the main controller 173. The timing controller 176 extracts a temperature compensation value corresponding to the received temperature compensation setting value using temperature compensation data stored in the storage unit 190. Subsequently, the timing controller 176 generates a driving signal by correcting the driving signal applied to the LCD module 130 according to the extracted temperature compensation value. By doing so, the timing controller 176 may manually apply temperature compensation to the input image signal according to the temperature of the LCD module 130.

The temperature sensor 180 senses the temperature of the LCD module 130. The temperature sensor 180 may be mounted on any part of the LCD module 130. For example, the temperature sensor 180 may be mounted on the center of the back of the LCD module 130. In addition, the temperature sensor 180 transmits temperature information of the sensed LCD module 130 to the timing controller 176.

The temperature sensor is divided into a contact-type and a non contact-type. According to the contact-type, temperature is measured through contact with a subject. Examples of the contact-type include a (platinum) resistance temperature sensor, a thermistor, a thermocouple, and a bimetal, and examples of the non contact-type include an infrared thermometer and an optical pyrometer. As such, the temperature sensor 180 may be implemented as various temperature sensors.

The storage unit 190 stores various information necessary to control timing of the LCD TV 100. In addition, the storage unit 150 stores temperate compensation data corresponding to compensation values of each temperature. Herein, temperature compensation data refers to a table showing compensation values for various temperatures. For example, temperature compensation data may be a DCC table set for each temperature. The storage unit 190 may be various storage media including an electrically erasable programmable read-only memory (EEPROM).

The LCD TV 100 drives an LCD by applying temperature compensation by the main controller 176, and thus, may maintain fast response speed in low temperature. Accordingly, the LCD TV 100 may reduce cross-talk effect while displaying a 3D image.

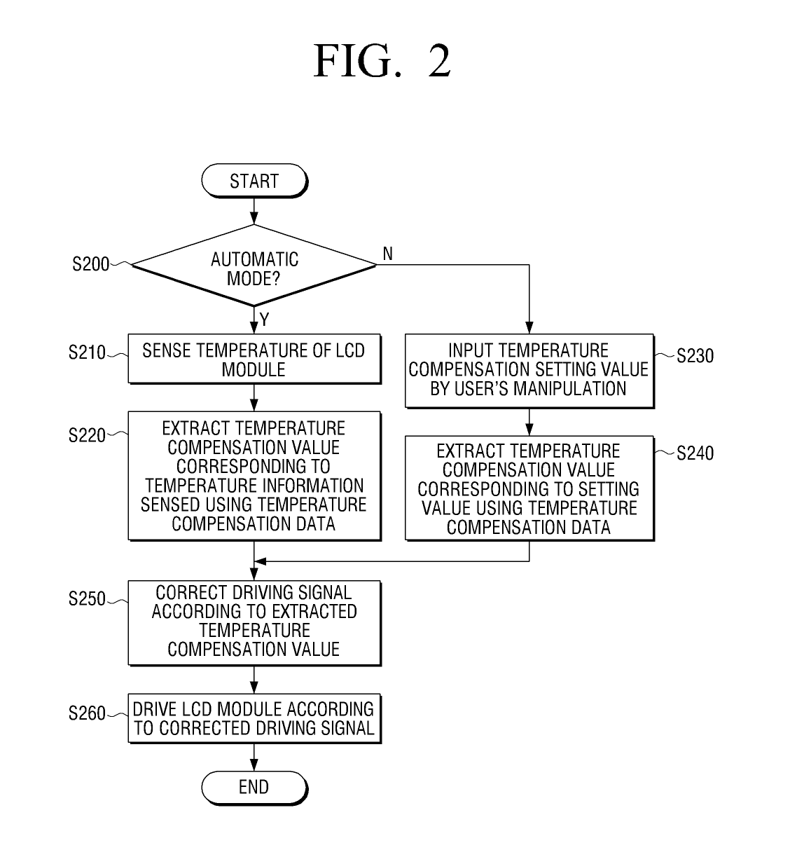

Hereinafter, a method for driving the LCD TV 100 will be described in detail with reference to FIG. 2. FIG. 2 is a flowchart to explain an LCD driving method according to an exemplary embodiment.

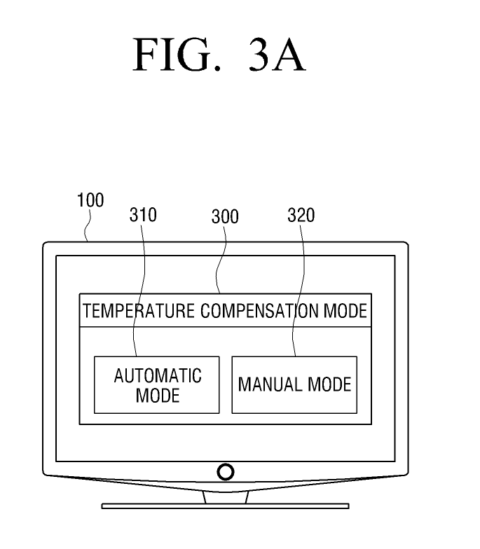

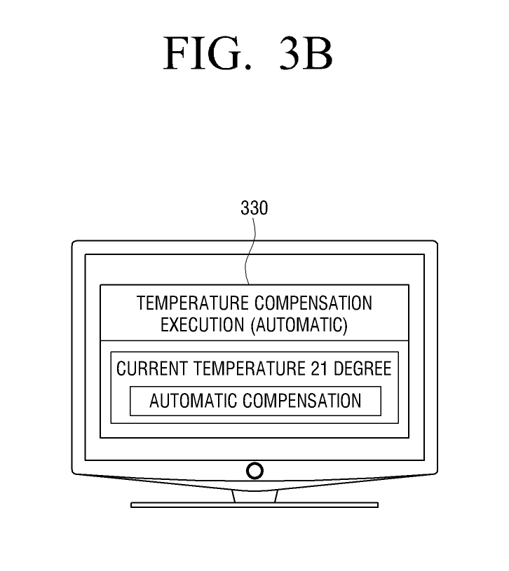

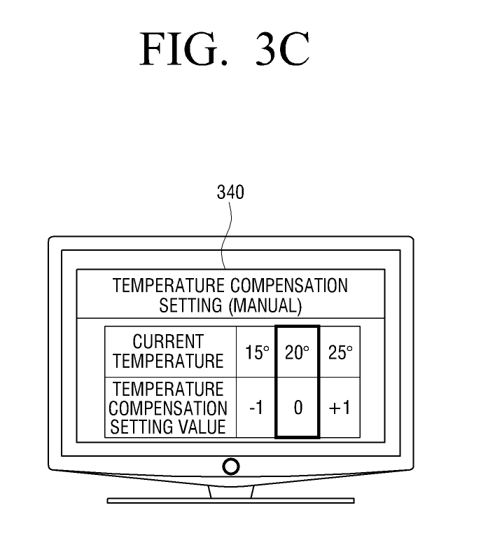

Firstly, the LCD TV 100 determines whether the current temperature compensation mode is an automatic mode or a manual mode (S200). Specifically, the LCD TV 100 determines which temperature compensation mode is set by a user, which will be explained with reference to FIG. 3A.

FIG. 3A is a view illustrating a screen to set a temperature compensation mode according to an exemplary embodiment. As illustrated in FIG. 3A, the LCD TV 100 displays a window 300 on a screen to select a temperature compensation mode. The temperature mode selection window 300 comprises an automatic mode icon 310 and a manual mode icon 320.

If the automatic mode icon 310 is selected by a user, the LCD TV 100 sets a temperature compensation mode automatically. If the manual mode icon 320 is selected by a user, the LCD TV 100 sets a temperature compensation mode manually.

As such, the LCD TV 100 may provide a graphic user interface (GUI) to allow a user to select a temperature compensation mode.

Referring back to FIG. 2, if a current mode is an automatic mode (S200-Y), the LCD TV 100 senses the temperature of the LCD module 130 through a temperature sensor (S210). Subsequently, the LCD TV 100 extracts a temperature compensation value corresponding to temperature information using the stored temperature compensation data (S220). The automatic mode will be explained in detail below with reference to FIG. 3B.

FIG. 3B is a view illustrating a screen when a temperature compensation mode is set to an automatic mode according to an exemplary embodiment. As illustrated in FIG. 3B, if a temperature compensation mode is set to an automatic mode, the LCD TV 100 displays a temperature compensation setting execution window 330 on a screen. In this case, it can be seen that the current temperature sensed by a temperature sensor is displayed on the temperature compensation execution window 330.

If a temperature compensation mode is set to an automatic mode, temperature compensation is applied automatically without a user's manipulation.

Referring back to FIG. 2, if a current mode is a manual mode (S200-N), the LCD TV 100 receives a temperature compensation setting value by a user's manipulation (S230). The LCD TV 100 extracts a temperature compensation value corresponding to a temperature compensation value using the stored temperature compensation data (S240). A manual mode will be explained below with reference to FIG. 3C.

FIG. 3C is a view illustrating a screen when a temperature compensation mode is set to a manual mode according to an exemplary embodiment. As illustrated in FIG. 3C, if a temperature compensation mode is a manual mode, the LCD TV 100 displays a temperature compensation setting window 340 on a screen. It can be seen that a temperature compensation setting value for each temperature is displayed on the temperature compensation setting window 340. Accordingly, a user may select a temperature compensation setting value taking the current temperature into consideration.

As such, the LCD TV 100 may provide a GUI for a user to select a temperature compensation setting value.

Referring back to FIG. 2, the LCD TV 100 corrects a driving signal according to the extracted temperature compensation value (S250). In addition, the LCD TV 100 drives the LCD module according to the corrected driving signal (S260).

By doing so, the LCD TV 100 may apply temperature compensation to a driving signal according to the temperature of the LCD module 130 automatically or manually.

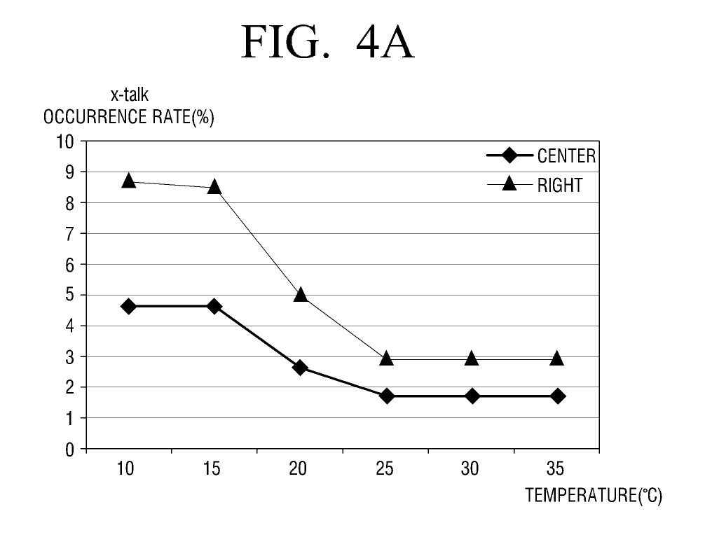

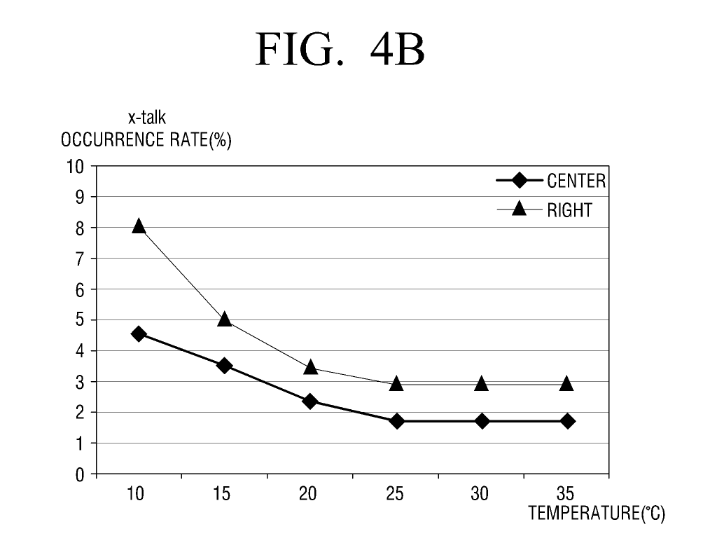

FIGS. 4A and 4B are views illustrating graphs showing a cross-talk occurrence rate before and after applying temperature compensation according to an exemplary embodiment.

FIG. 4A is a graph illustrating a cross-talk occurrence rate before applying temperature compensation. As illustrated in FIG. 4A, a cross-talk occurrence rate is high when temperature is below 25 degrees.

FIG. 4B is a graph illustrating a cross-talk occurrence rate after applying temperature compensation. As illustrated in FIG. 4B, after temperature compensation is applied, a cross-talk occurrence rate becomes lower than the cross-talk occurrence rate in FIG. 4A when temperature is below 25 degrees (Celsius).

The LCD TV 100, according to an exemplary embodiment, may lower a cross-talk occurrence rate by applying temperature compensation to drive the LCD module. Accordingly, a user may view a clear 3D image without cross-talk effect.

In the above exemplary embodiment, a display apparatus is the LCD TV 100, but this is only an example. Any LCD display apparatus could be a display apparatus. For example, an LCD apparatus may be applied to a 3D LCD TV, a general LCD TV, an LCD monitor, or a notebook computer.

Although a few exemplary embodiments have been shown and described, it would be appreciated by those skilled in the art that changes may be made to those exemplary embodiments without departing from the principles and spirit of the inventive concept, the scope of which is defined in the claims and their equivalents.

What is claimed is:

1. A liquid crystal display (LCD) apparatus, comprising:
an LCD module which displays an input image; and
a controller which drives the LCD module by applying temperature compensation to change driving timing of the LCD module according to temperature of the LCD module.

2. The LCD apparatus as claimed in claim 1, wherein the controller comprises:
a timing controller which controls the driving timing of the LCD module based on the input image; and
a main controller which controls the timing controller to control the driving timing based on the input image,
wherein the main controller controls the timing controller to drive the LCD module by applying the temperature compensation to change the driving timing controlled based on the input image according to the temperature of the LCD module.

3. The LCD apparatus as claimed in claim 2, further comprising:
a temperature sensor which senses the temperature of the LCD module,
wherein the main controller applies the temperature compensation according to the temperature of the LCD module sensed by the temperature sensor.

4. The LCD apparatus as claimed in claim 3, further comprising:
a storage unit which stores temperature compensation data comprising a plurality of temperature compensation values corresponding to a plurality of temperatures, respectively,
wherein the main controller extracts from the storage unit a temperature compensation value corresponding to the temperature, and applies the temperature compensation using the extracted temperature compensation value.

5. The LCD apparatus as claimed in claim 4, wherein the main controller controls the timing controller to correct a driving signal to drive the LCD module according to the extracted temperature compensation value.

6. The LCD apparatus as claimed in claim 2, wherein the main controller applies the temperature compensation according to a setting value set by a user's manipulation.

7. The LCD apparatus as claimed in claim 1, wherein the main controller comprises:
a timing controller which controls driving timing of the LCD module according to the input image; and
a main controller which controls the timing controller to control the driving timing according to an input image,
wherein the timing controller drives the LCD module by applying the temperature compensation to change the driving timing according to the temperature of the LCD module.

8. The LCD apparatus as claimed in claim 7, further comprising:
a temperature sensor which senses the temperature of the LCD module,
wherein the timing controller applies the temperature compensation according to the temperature of the LCD module sensed by the temperature sensor.

9. The LCD apparatus as claimed in claim 8, further comprising:
a storage unit which stores temperature compensation data comprising a plurality of temperature compensation values corresponding to a plurality of temperatures, respectively,
wherein the timing controller extracts from the storage unit a temperature compensation value corresponding to the temperature, and applies the temperature compensation using the extracted temperature compensation value.

10. The LCD apparatus as claimed in claim 9, wherein the timing controller corrects a driving signal to drive the LCD module according to the extracted temperature compensation value.

11. The LCD apparatus as claimed in claim 7, wherein the timing controller applies the temperature compensation according to a setting value set by a user's manipulation.

12. A method of driving a liquid crystal display (LCD), the method comprising;
applying temperature compensation to a driving signal to drive an LCD module, according to temperature of the LCD module; and
changing driving timing of the LCD module according to the driving signal to which the temperature compensation is applied.

13. The LCD driving method as claimed in claim 12, further comprising:
sensing the temperature of the LCD module by a temperature sensor.

14. The LCD driving method as claimed in claim 13, further comprising:
storing temperature compensation data comprising a plurality of temperature compensation values corresponding to a plurality of temperatures, respectively; and
extracting a temperature compensation value corresponding to the temperature from the stored temperature compensation data,
wherein the applying the temperature compensation is performed using the extracted temperature compensation value.

15. The LCD driving method as claimed in claim 14, wherein the applying the temperature compensation comprises applying the temperature compensation to correct the driving signal according to the extracted temperature compensation value.

16. The LCD driving method as claimed in claim 12, further comprising:
receiving an input of a setting value regarding the temperature compensation by a user's manipulation,
wherein the applying comprises applying the temperature compensation according to a setting value set by a user's manipulation.

17. An apparatus for compensating temperature of a liquid crystal display (LCD), the apparatus comprising:
a controller which generates a driving signal used to drive the LCD based on an input image to be displayed on the LCD, according to a temperature of the LCD.

18. The apparatus of claim 17, wherein the driving signal is generated by adjusting a current, a voltage, or a duty ratio applied to the LCD, according to the temperature of the LCD.

19. The apparatus of claim 17, wherein, by generating the driving signal according to the temperature of the LCD, the controller changes driving timing of the LCD which is controlled according to the input image.

20. The apparatus of claim 19, wherein the temperature of the LCD is temperature of a center area of the LCD.
